(19) United States
(12) Patent Application Publication
(10) Pub. No.: US 2016/0198765 A1
(43) Pub. Date: Jul. 14, 2016

(54) ELECTRONIC CIGARETTE

(71) Applicant: KIMREE HI-TECH INC., Tortola (VG)

(72) Inventor: Qiuming Liu, Shenzhen, Guangdong (CN)

(73) Assignee: KIMREE HI-TECH INC., Tortola (VG)

(21) Appl. No.: 14/912,167

(22) PCT Filed: Aug. 16, 2013
(86) PCT No.: PCT/CN2013/081701

§ 371 Date: Feb. 16, 2016

(51) Int. Cl. A24F 47/00; H05B 1/02

(52) U.S. Cl. CPC A24F 47/008; H05B 1/0244

(57) ABSTRACT

An electronic cigarette comprising an outer sleeve pipe (1) and a light cap (2) arranged at one extremity of the outer sleeve pipe (1). A snapping-connection structure is provided on the light cap (2). The snapping-connection structure is either a snapping-connection part (23), a snapping-connection piece (4) or a snapping-connection ring (5). An insertion part (22) is arranged within the outer sleeve pipe (1). The snapping-connection part (23) extends from the outer wall of the insertion part (22) towards the inner wall of the outer sleeve pipe (1). The light cap (2) is snappingly connected with the outer sleeve pipe (1) via the snapping-connection part (23).

### THCHNICAL FIELD

The present application relates to the field of household electronics, and more particularly relates to an electronic cigarette.

### BACKGROUND OF THE APPLICATION

The electronic cigarette is mainly used for smoking cessation and replacing cigarettes. As shown in FIG. 1, the electronic cigarette in the prior art comprises an outer sleeve pipe 1 and a light cap 2 arranged on one end of the outer sleeve pipe 1. A luminaire electronically connected to the control module of the electronic cigarette is arranged inside the light cap 2. When the electronic cigarette is working, the control module drives the luminaire inside the light cap 2 to mimic the burning tobacco. The light cap 2 is usually inserted into the outer sleeve pipe 1 via an interference-fit connection. But when using this connection, the light cap 2 mounted in the outer sleeve pipe 1 has a bad performance in reliability, which causes the light cap 2 easily falling off from the outer sleeve pipe 1.

### SUMMARY OF THE APPLICATION

The objective of the present application is to provide an electronic cigarette which has a light cap firmly mounted on an outer sleeve pipe, aiming at the above-mentioned drawback that the light cap is easily falling off from the outer sleeve pipe.

The technical solutions of the present application for solving the technical problems are as follows:

An electronic cigarette, comprising an outer sleeve pipe, wherein, the electronic cigarette further comprises a light cap arranged at one extremity of the outer sleeve pipe; a snapping-connection structure is provided on the light cap; the light cap is snappingly connected with the outer sleeve pipe via the snapping-connection structure.

In the electronic cigarette of the present application, the snapping-connection structure is a snapping-connection part or snapping-connection piece or snapping-connection ring.

In the electronic cigarette of the present application, the light cap comprises an insertion part arranged inside the outer sleeve pipe; the snapping-connection part extends from an outer wall of the insertion part towards an inner wall of the outer sleeve pipe; the snapping-connection part is snappingly connected with the outer sleeve pipe.

In the electronic cigarette of the present application, the light cap comprises a main body defined outside of the outer sleeve pipe; the insertion part extends from the main body towards an inside of the outer sleeve pipe.

In the electronic cigarette of the present application, the light cap further comprises a mounting groove opened on the insertion part; the mounting groove is opened towards the inner wall of the outer sleeve pipe; the electronic cigarette further comprises a fastener; the fastener is mounted on the mounting groove and is abutted against the inner wall of the outer sleeve pipe.

In the electronic cigarette of the present application, both the mounting groove and the fastener have an annular structure.

In the electronic cigarette of the present application, the light cap further comprises an unloading force groove axially opened along the insertion part.

In the electronic cigarette of the present application, a snapping-connection position is defined on an inner wall of the outer sleeve pipe; the light cap comprises an insertion part arranged inside the outer sleeve pipe; the snapping-connection part extends from an outer wall of the insertion part towards the inner wall of the outer sleeve pipe; the snapping-connection part is clamped inside of the snapping-connection position.

In the electronic cigarette of the present application, the light cap comprises a main body defined outside of the outer sleeve pipe; the insertion part extends from the main body towards an inside of the outer sleeve pipe.

In the electronic cigarette of the present application, the snapping-connection position has a through hole structure.

In the electronic cigarette of the present application, the outer sleeve pipe comprises an atomizing sleeve and a battery cartridge detachably connected to the atomizing sleeve; the light cap is mounted on one end of the battery cartridge and the end is away from the atomizing sleeve.

In summary, when implementing the electronic cigarette of the present application, the following advantageous effects can be achieved: by providing a snapping-connection structure on the light cap of the electronic cigarette, the light cap is firmly inserted in the outer sleeve pipe and it can be effectively avoided the light cap from falling off from the outer sleeve pipe; furthermore, by defining a snapping-connection position on an inner wall of the outer sleeve pipe of the electronic cigarette, it further improves the reliability between the light cap and the outer sleeve pipe.

### BRIEF DESCRIPTION OF THE DRAWINGS

The present application will be further described with reference to the accompanying drawings and embodiments in the following, in the accompanying drawings:

FIG. 1 is a structure schematic view of an end of an electronic cigarette with a light cap defined on it in the prior art.

FIG. 2 is an exploded view of an end of the electronic cigarette with a light cap, according to a preferred embodiment of the present application;

FIG. 3 to FIG. 5 is structure schematic views of a snapping-connection structure of the electronic cigarette shown in FIG. 2, according to different embodiments of the present application;

FIG. 6 is an exploded view of an end of the electronic cigarette with a light cap, according to a second preferred embodiment of the present application;

FIG. 7 is a structure schematic view of an end of an electronic cigarette with a light cap, according to the electronic cigarette of FIG. 6.

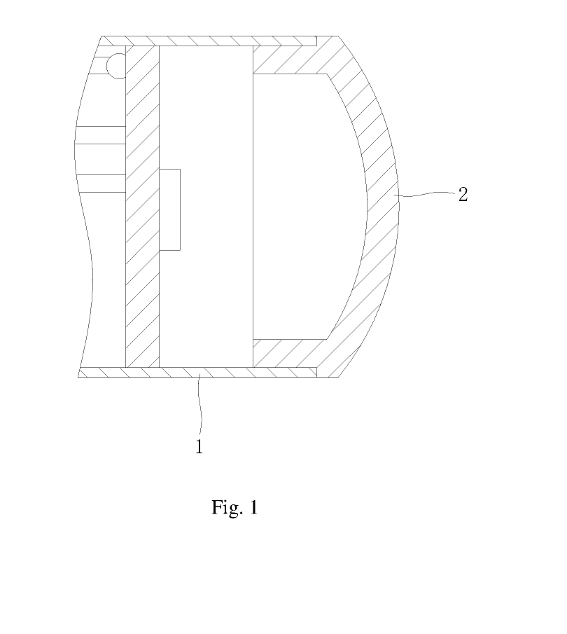

### DETAILED DESCRIPTION OF THE PREFERRED EMBODIMENT

To make the technical feature, objective and effect of the present application be understood more clearly, now the specific implementation of the present application is described in detail with reference to the accompanying drawings and embodiments. It should be understood that the specific embodiments described herein are only used to explain the present application and are not intended to limit the present application.

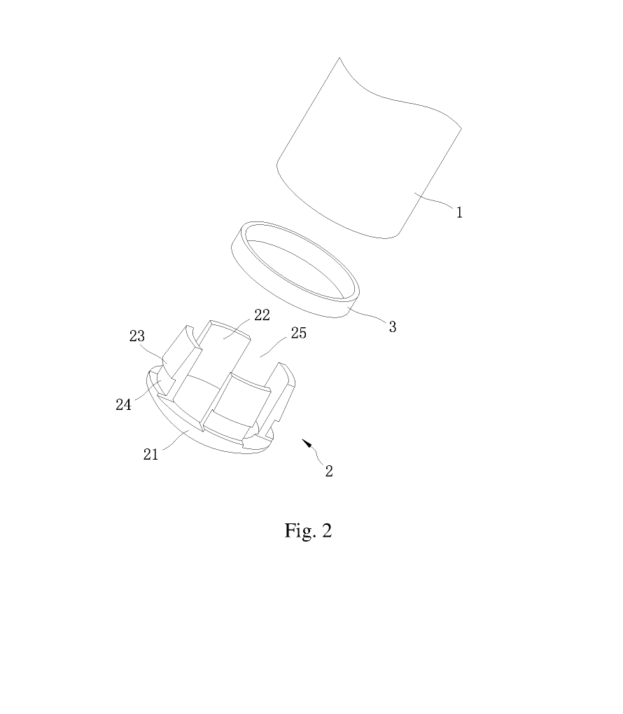

As shown in FIG. 2, according to a preferred embodiment of the present application, an electronic cigarette is provided, which comprises an outer sleeve pipe 1, a light cap 2 and a fastener 3. The outer sleeve pipe 1 has a substantially hollow cylindrical structure, and the light cap 2 is provided on one end of the outer sleeve pipe 1.

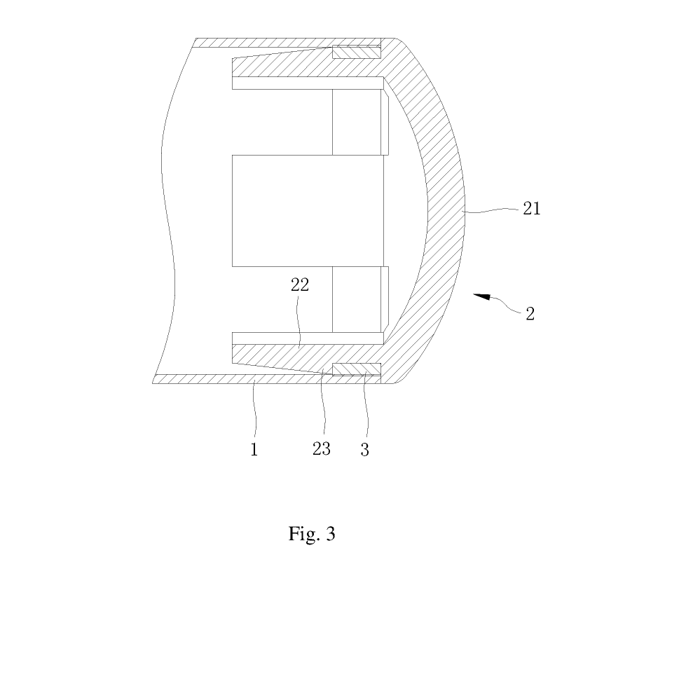

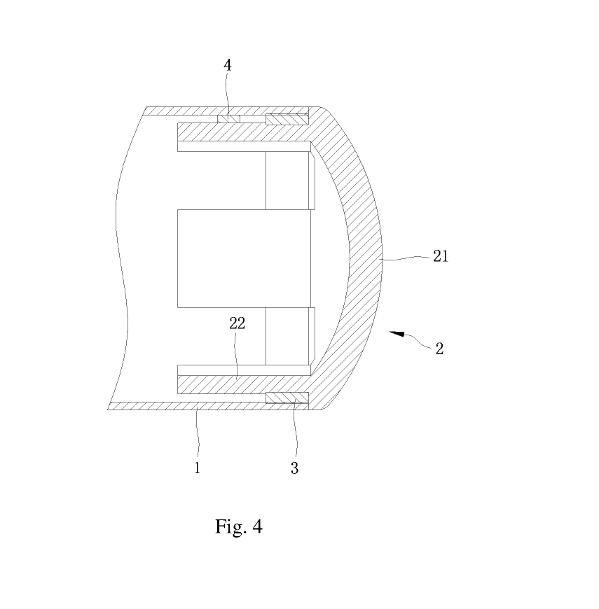

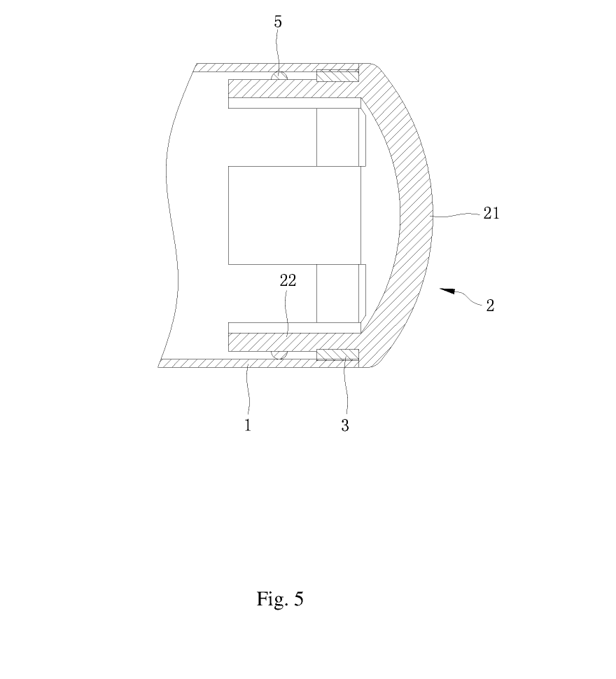

As shown in FIG. 2 and FIG. 3, the light cap 2 comprises a main body 21, an insertion part 22, a snapping-connection structure, a mounting groove 24 and an unloading force groove 25. The main body 21 has a substantially cylindrical structure and is defined outside of the outer sleeve pipe 1. The insertion part 22 has a substantially hollow cylindrical structure and is arranged inside the outer sleeve pipe 1. The insertion part 22 extends from the main body 21 towards an inside of the outer sleeve pipe 1. The snapping-connection structure is provided on the insertion part 22. In this embodiment, the snapping-connection structure is the snapping-connection part 23. The snapping-connection part 23 extends from an outer wall of the insertion part 22 towards an inner wall of the outer sleeve pipe 1 and the snapping-connection part 23 is snappingly connected with the outer sleeve pipe 1. As shown in FIG. 4 and FIG. 5, in other embodiments of the application, the snapping-connection structure is a snapping-connection piece 4 or a snapping-connection ring 5. The snapping-connection piece 4 and the snapping-connection ring 5 respectively provided on the outer wall of the insertion part 22, and the snapping-connection piece 4 and the snapping-connection ring 5 are respectively snappingly connected with the outer sleeve pipe 1.

As shown in FIG. 2, the mounting groove 24 has an annular structure, and it is opened on the insertion part 22 and is opened towards the inner wall of the outer sleeve pipe 1. The mounting groove 24 is used for mounting the fastener 3. The unloading force groove 25 is axially opened along the insertion part 22. In this embodiment, four unloading force grooves 25 are provided, and the four unloading force grooves 25 are uniformly defined on the outer wall of the insertion part 22. By using the unloading force groove 25, the light cap 2 can be easily inserted into the outer sleeve pipe 1.

As shown in FIG. 2, the fastener 3 has an annular structure, and it is mounted on the mounting groove 24 and is snappingly connected with the outer sleeve pipe 1. By using the fastener 3, the light cap 2 can be further firmly inserted into the outer sleeve pipe 1.

As shown in FIG. 2 and FIG. 3, when assembled, the fastener 3 is firstly mounted in the outer sleeve pipe 1, and then the light cap 2 is inserted into one end of the outer sleeve pipe 1 to make the fastener 3 clamped into the mounting groove 24, which realizing the snapping-connection between the light cap 2 and the outer sleeve pipe 1. Since the light cap 2 of the electronic cigarette has the snapping-connection part 23 , it makes the light cap 2 can be firmly inserted into the outer sleeve pipe 1 and thus it effectively avoids the light cap 2 falling off from the outer sleeve pipe 1.

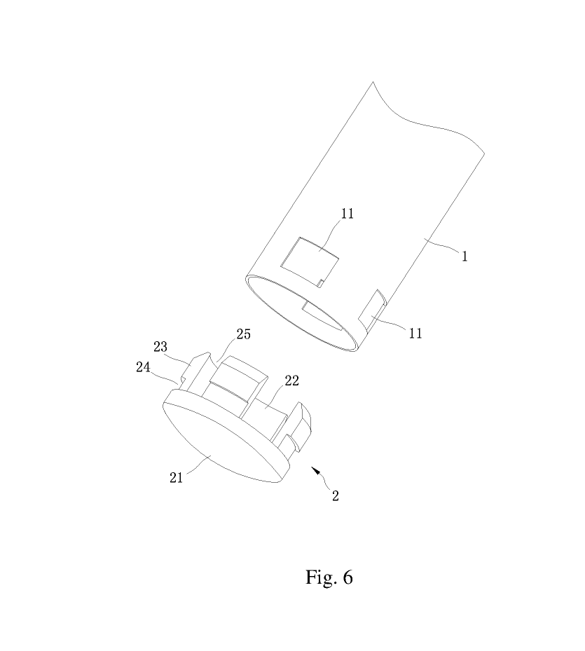

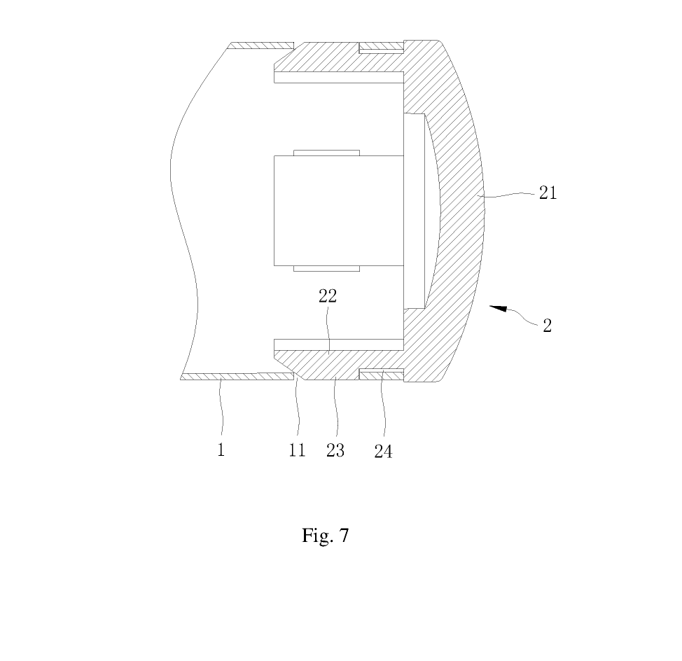

As shown in FIG. 6 and FIG. 7, an electronic cigarette is provided according to a second preferred embodiment of the present application, the difference between the electronic cigarette provided by the second preferred embodiment and the electronic cigarette provided by the first preferred embodiment is the structure of the outer sleeve pipe 1. In this embodiment, the fastener 3 is not included. A snapping-connection position 11 is defined on an inner wall of the outer sleeve pipe 1 and the snapping-connection position 11 has a through hole structure which is adapted to the location of the snapping-connection part 23. When the light cap 2 is inserted into the outer sleeve pipe 1, the snapping-connection part 23 is clamped inside of the snapping-connection position 11. Since the outer sleeve pipe 1 of the electronic cigarette has the snapping-connection position 11, it further improves the reliability between the light cap 2 and the outer sleeve pipe 1.

In another embodiment of the present application, the difference between it and the above embodiment one and embodiment two is the structure of the outer sleeve pipe 1. In this embodiment, the outer sleeve pipe 1 comprises an atomizing sleeve (not shown) and a battery cartridge (not shown) detachably connected on the atomizing sleeve. The light cap 2 is mounted on one end of the battery cartridge and the end is away from the atomizing sleeve.

While the embodiments of the present application are described with reference to the accompanying drawings above, the present application is not limited to the above-mentioned specific implementations. In fact, the above-mentioned specific implementations are intended to be exemplary not to be limiting. In the inspiration of the present application, those ordinary skills in the art can also make many modifications without breaking away from the subject of the present application and the protection scope of the claims. All these modifications belong to the protection of the present application.

1. An electronic cigarette, comprising an outer sleeve pipe (1) and a light cap (2) arranged at one extremity of the outer sleeve pipe (1);
wherein a snapping-connection structure is provided on the light cap (2); the light cap (2) is snappingly connected with the outer sleeve pipe (1) via the snapping-connection structure.

2. The electronic cigarette according to claim 1, wherein the snapping-connection structure is a snapping-connection part (23) or snapping-connection piece (4) or snapping-connection ring (5).

3. The electronic cigarette according to claim 2, wherein the light cap (2) comprises an insertion part (22) arranged inside the outer sleeve pipe (1); the snapping-connection part (23) extends from an outer wall of the insertion part (22) towards an inner wall of the outer sleeve pipe (1); the snapping-connection part (23) is snappingly connected with the outer sleeve pipe (1).

4. The electronic cigarette according to claim 3, wherein the light cap (2) comprises a main body (21) defined outside of the outer sleeve pipe (1); the insertion part (22) extends from the main body (21) towards an inside of the outer sleeve pipe (1).

5. The electronic cigarette according to claim 3, wherein the light cap (2) further comprises a mounting groove (24) opened on the insertion part (22);
wherein the mounting groove (24) is opened towards the inner wall of the outer sleeve pipe (1);
the electronic cigarette further comprises a fastener (3); the fastener (3) is mounted on the mounting groove (24) and is abutted against the inner wall of the outer sleeve pipe(1).

6. The electronic cigarette according to claim 5, wherein both the mounting groove (24) and the fastener (3) have an annular structure.

7. The electronic cigarette according to claim 3, wherein the light cap (2) further comprises an unloading force groove (25) axially opened along the insertion part (22).

8. The electronic cigarette according to claim 2, wherein a snapping-connection position (11) is defined on an inner wall of the outer sleeve pipe (1);
wherein the light cap (2) comprises an insertion part (22) arranged inside the outer sleeve pipe(1); the snapping-connection part (23) extends from an outer wall of the insertion part (22) towards the inner wall of the outer sleeve pipe(1); and
wherein the snapping-connection part (23) is clamped inside of the snapping-connection position (11).

9. The electronic cigarette according to claim 8, wherein the light cap (2) comprises a main body (21) defined outside of the outer sleeve pipe (1); the insertion part (22) extends from the main body (21) towards an inside of the outer sleeve pipe (1).

10. The electronic cigarette according to claim 9, wherein the snapping-connection position (11) has a through hole structure.

11. The electronic cigarette according to claim 1, wherein the outer sleeve pipe (1) comprises an atomizing sleeve and a battery cartridge detachably connected to the atomizing sleeve; the light cap (2) is mounted on one end of the battery cartridge and the end is away from the atomizing sleeve.

12. An electronic cigarette, comprising an outer sleeve pipe (1) and a light cap (2) arranged at one extremity of the outer sleeve pipe (1);
wherein the light cap (2) comprises a main body (21) defined outside of the outer sleeve pipe (1), an insertion part (22) arranged inside the outer sleeve pipe(1), a snapping-connection part (23) extended from an outer wall of the insertion part (22) towards an inner wall of the outer sleeve pipe(1); a mounting groove (24) axially opened along the insertion part (22), the mounting groove (24) is opened towards the inner wall of the outer sleeve pipe (1), four unloading force grooves (25) being uniformly defined on the outer wall of the insertion part (22);
wherein the electronic cigarette further comprises a fastener (3); the fastener (3) is mounted on the mounting groove (24) and is abutted against the inner wall of the outer sleeve pipe(1); and
wherein the snapping-connection part (23) is snappingly connected with the outer sleeve pipe (1).
